(19) United States
(12) Patent Application Publication
(10) Pub. No.: US 2006/0175561 A1
(43) Pub. Date: Aug. 10, 2006

(54) Particle shadow velocimetry

(75) Inventors: Jordi Estevadeordal, Fairborn, OH (US); Larry P. Goss, Beavercreek, OH (US)

Correspondence Address: STEVENS & SHOWALTER LLP, 7019 CORPORATE WAY, DAYTON, OH, 45459-4238, US

(73) Assignee: Innovative Scientific Solutions, Inc., Dayton, OH (US)

(21) Appl. No.: 11/350,472

(22) Filed: Feb. 9, 2006

Related U.S. Application Data
(60) Provisional application No. 60/651,402, filed on Feb. 9, 2005.

(51) Int. Cl. G01N 21/85; G01N 15/06

(52) U.S. Cl. 250/573

(57) ABSTRACT

A method of measuring fluid flow including the steps of providing a light source including at least one LED, providing an image detecting element and defining an illuminated measurement space with an optical element located between the measurement space and the image detecting element. The measurement space is located optically in-line between the light source and the image detecting element. The method further includes the steps of providing a fluid flow through the measurement space, the fluid flow including particles, and illuminating the measurement space with the light source to induce light extinction from the particles comprising shadow markers of the position of the particles within the fluid flow. The image detecting element is used to detect the shadow markers produced by the particles to record displacement of the particles as a function of time corresponding to movement of the fluid flow. In a further aspect, the light source includes plural LEDs emitting different colors.

### CROSS-REFERENCE TO RELATED APPLICATIONS

This application claims the benefit of U.S. Provisional Application No. 60/651,402, filed Feb. 9, 2005, which is incorporated herein by reference.

### BACKGROUND OF THE INVENTION

1. Field of the Invention

The present invention relates generally to fluid velocity and acceleration measurements based on the imaging of seed particles in fluid flows and, more particularly, relates to measuring fluid velocity and acceleration by imaging particles in a shadow mode using in-line illumination.

2. Description of Prior Art

Particle Image Velocimetry (PIV) is a powerful diagnostic technique capable of providing accurate spatially resolved velocity fields in a variety of flows. Generally PIV measurement techniques determine the velocity of a flow based on recorded traces of moved objects, e.g., seed particles. Typically, the recorded traces may be acquired by an image detector optically focused on an illuminated measurement space. The detected particle traces provide graphical information from which the velocity field of a flow in the illuminated measurement space may be inferred.

High-speed PIV is becoming increasingly important with the emergence of high-speed laser sources and high-speed video cameras. Many PIV techniques require laser light sources that are capable of high-power, short-duration pulses, allowing instantaneous marking of seed particles and detection of the particles through capture of light scattered from the seed particles with a camera. Presently lasers are the most expensive component of PIV systems, despite their relatively low repetition rates in their commercial form. High-speed PIV is even more costly since it requires both a high-repetition-rate laser and a high-speed camera.

One form of PIV for studying flows is known as microscopic PIV. Microscopic PIV approaches are often based on either fluorescent tagging of particles or on light scattering though transmitted-light microscopy. In the fluorescent tagging approaches, particles suspended in the flow, e.g., polystyrene latex (PSL) particles, are tagged with a dye to excite at certain wavelength. The dye is typically chosen close to absorb Nd:YAG laser wavelengths and to emit at another, shifted wavelength, i.e. at a red shifted wavelength. The shifted wavelength light is detected to register the tagged particles and define the velocity field. Such an arrangement requires optical elements to receive the scattered light, and may further include optical elements to focus the source laser light to form a “light sheet” or a spatially defined area where the laser light will cause the fluorescent tagged particles to undergo a shift in wavelength, and the wavelength shifted light is sensed by a receiving device.

In the transmitted-light microscopy approaches, light is transmitted from a source, and through a condenser to focus it on a specimen for obtaining very high illumination. The light passing through the specimen causes the image of the specimen to go through the objective lens and to an oculars, where an enlarged image of the specimen may be viewed or otherwise detected. The described transmitted-light microscopy approach for specimen imaging may incorporate Köhler illumination, which is a widely used setup for proper specimen illumination and image generation. In the case of using the described transmitted-light technique to determine particle velocity in the specimen, detection of the location of particles is based on detection of forward scattering of light from the particles.

In a known miniature PIV approach to study flows, LEDs may be used to illuminate particles suspended in a flow, and either forward, backward or side-scattering of light from the particles may be detected. However, LEDs have a relatively weak light output as compared to lasers, and due to the weak scattering from the LEDs, this approach may provide a reduced detection of particles and be limited to small sampling areas, i.e., have a limited field of view.

Another velocimetry technique known in the art involves the use of holography, which may be used to measure flow velocities in three dimensions. Typical holographic PIV techniques use a coherent laser and, as in other PIV techniques, flow information is obtained based on scattered light.

In a further known technique, particle size measurements may be obtained by illuminating particles with a laser or a flash lamp to create particle shadows. The particle shadows may additionally be used to determine velocities of the particles.

Accordingly, it can be seen that known PIV techniques have generally relied on a relatively powerful source, such as a laser, to ensure that sufficient light energy is available to scatter or image the particle to contrast with background light. Such techniques for velocimetry have proven limited in the range of velocities that may be measured by a given set-up, and may provide a limited scope of data for facilitating particle movement determinations.

### SUMMARY OF THE INVENTION

The present invention provides a particle velocimetry method that is capable of utilizing light sources with substantially lower power than lasers while providing an accurate spatially resolved velocity field.

In accordance with one aspect of the invention, a method of measuring fluid flow is provided including the steps of providing a light source comprising at least one LED, providing an image detecting element, defining an illuminated measurement space with an optical element located between the measurement space and the image detecting element, wherein the measurement space is located optically in-line between the light source and the image detecting element. The method further includes the steps of providing a fluid flow through the measurement space, the fluid flow including particles, and illuminating the measurement space with the light source to induce light extinction of the particles comprising shadow markers of the position of the particles within the fluid flow. The image detecting element is used to detect the shadow markers produced by the particles to record displacement of the particles as a function of time corresponding to movement of the fluid flow.

In accordance with another aspect of the invention, a method of measuring fluid flow is provided including the steps of projecting a light from a light source comprising at least first and second LEDs emitting different colors through a fluid flow seeded with particles to provide an illuminated measurement space, imaging particle shadows from a portion of the illuminated measurement space to an image recording device, and identifying particle locations from the particle shadows imaged to the image recording device.

### BRIEF DESCRIPTION OF THE DRAWINGS

While the specification concludes with claims particularly pointing out and distinctly claiming the present invention, it is believed that the present invention will be better understood from the following description in conjunction with the accompanying Drawing Figures, in which like reference numerals identify like elements, and wherein:

FIG. 1 illustrates an arrangement of optical elements forming an apparatus for performing a method in accordance with the present invention;

FIG. 2A illustrates a prior art PIV imaging system for collecting scattered light;

FIG. 2B illustrates the in-line shadow imaging method of the present invention;

FIG. 3 illustrates the present invention with reference to the depth of field for obtaining particle shadow data from a measurement space;

FIG. 4A illustrates an image produced using a light scattering PIV setup;

FIG. 4B illustrates an image produced using a PSV setup;

FIG. 5 is a graph illustrating the time for one pulse of an LED;

FIG. 6 illustrates a train of LED pulses occurring at approximately 1 μsec intervals;

FIG. 7 illustrates a train of LED pulses occurring at approximately 200 nsec intervals;

FIG. 8 illustrates a timing for providing LED pulses from different color LEDs in relation to different image frames captured by a camera; and

FIG. 9 illustrates an optical arrangement for obtaining a stereo image of a measurement space using two LEDs emitting different color light.

### DETAILED DESCRIPTION OF THE INVENTION

The method and associated apparatus or system described herein comprises a non-scattering particle image velocimetry (PIV) technique for detecting particle displacement as a function of time in order to obtain velocity and acceleration measurement information from a fluid flow. In particular, the following description is directed to a method of detecting particle and/or particle ensemble locations within a fluid flow with reference to shadows defined by the particles as they are illuminated by a light source, defined herein as particle shadow velocimetry (PSV).

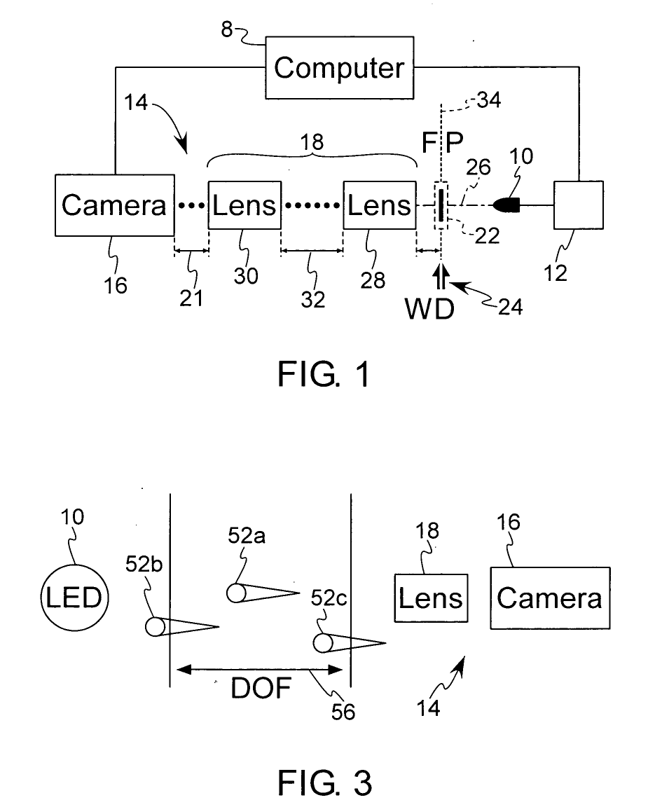

Referring to FIG. 1, an optical setup for performing the present method is illustrated diagrammatically and includes a light source 10, a pulser 12 for powering the light source 10 at a predetermined pulse rate, and an image detecting system 14 comprising a camera 16, connected to a lens element or lens system 18 wherein the spacing 21 between the lens system 48 and the camera 16 may be adjusted. A computer 8 may also be provided connected to the pulser 12 and to the camera 16 for controlling operation of the system. A fluid flow region 22 is provided between the light source 10 and the image detecting system 14, the fluid flow region 22 being generally defined by a fluid flow 24 passing substantially transverse or perpendicular to a center-line 26 extending from the light source 10 through the image detecting system 14.

The fluid flow preferably includes objects that may be imaged by the light source 10 to the image detecting system 14. For the purpose of the present description the objects will be referred to as particles, and may preferably comprise particles sized within a range from approximately 0.5 μm to approximately 10 μm. In addition to solid particles, the objects or particles may also comprise bubbles, such as air bubbles in the fluid flow. For purposes of the present discussion, the flow will be described with reference to a gaseous flow that is seeded with particles on the order of 0.5-10 μm. However, it should be understood that the present method is not limited to a particular particle size, and particles outside of the described range could also be utilized. It should also be understood that the present invention need not be limited to a seeded flow if the flow includes objects or particles of appropriate size and sufficient density for detection in accordance with the principles described herein.

As will be discussed in greater detail below, the light source 10 directs light through the fluid flow 24 in the flow region 22 to the image detecting system 14 and in doing so, the particles within the fluid flow 24 cause portions of the light to be blocked from passing to the image detecting system 14. In other words, the particles cast shadows to the image detecting system 14 to form particle shadow images at the camera 16, comprising shadows caused by extinction of the light as a consequence of absorption and scattering characteristics.

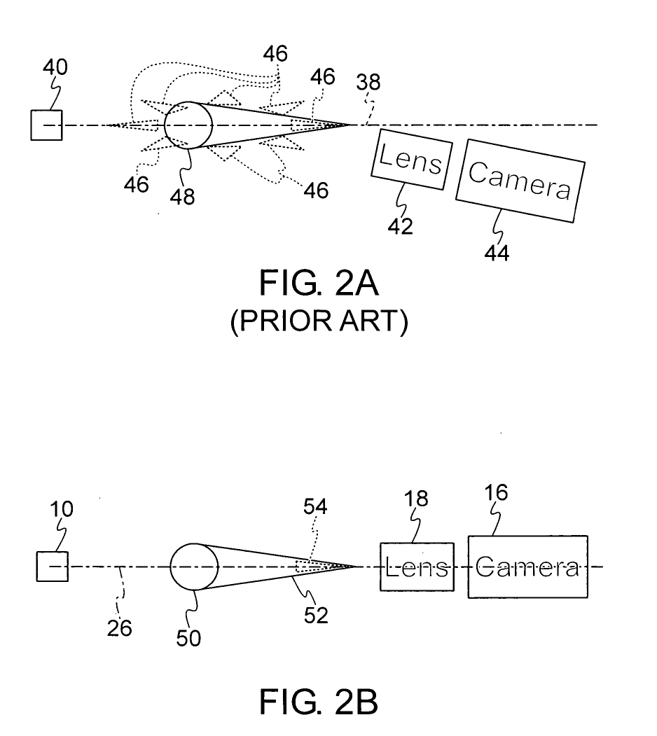

It should be understood that the present PSV technique does not rely on such prior art principles as fluorescence, scattering, coherence, Doppler, defocusing or tagging but rather implements a relatively more simple principle of detecting particle shadows cast on a bright background. This is a consequence of the in-line, zero-degree deviation, direct-illumination setup implemented in the present invention. FIGS. 2A and 2B illustrate the differences between collection of scattering (FIG. 2A) and collection of extinction (FIG. 2B), i.e., shadow casting (PSV), alignment setups. In the collection of scattering setup, an angular offset is provided between the location of the detection components of a lens 42 and a camera 44 and a line 38 extending from a light source 40 to a particle 48. This arrangement limits or avoids light from the light source 40 from being imaged to the camera 44, with a resulting reduction in contrast between scattered light and background light. Specifically, dotted lines 46 in FIG. 2A generally represent scattered light reflected from the particle 48 as forward-scattered, side-scattered and back-scattered light. The lens 42 and camera 44 are positioned to generally receive forward and side scattered light. Since the collection of scattered light setup is dependent on the scattered light being detected in contrast to the background light received from the light source, or other noise that may interfere with particle detection, this technique is dependent on the energy of the scattered light being sufficiently high relative to the energy of the background light, or noise, to provide a particle detection. Accordingly, the light source 40 may typically comprise a laser or other high energy light source.

In the PSV setup, the angular offset between the source and detection components is essentially zero. A particle that lies between the source and the detector will cast a shadow of a certain area, as determined by known light extinction characteristics. FIG. 2B illustrates the PSV setup in which the light source 10, the lens system 18 and camera 16 are aligned along the center-line 26, and a particle 50 is also passing through the center-line 26. A shadow 52 caused by extinction of light from the light source as a consequence of absorption and scattering characteristics extends in a direction toward the lens 18 and camera 16. It may be noted that in addition to extinction of the light in the area of shadow 52, some forward scattered light, depicted by 54, may also occur in this area; however, the only forward-scattered light that may adversely affect detection of the particle shadow, i.e., the light that would be scattered directly into the recorded image (shadow) of the particle, occurs over a very small angle and comprises a relatively small amount of light. The extinction of light in the area of the shadow is approximately ten times greater than the amount of forward-scattered light in the area of the shadow. Further, the remaining forward-scattered light, i.e., outside of the particle shadow area, contributes to increased background light in contrast to the-extinction in the particle shadow area, effectively increasing the effects of extinction and further offsetting the effects of any forward-scattered light in the area of the particle shadow. It is believed that the forward-scattered light outside the area of the shadow effectively increases the ratio of light extinction-to-forward scattered light from 10 to 1, for the area only within the particle shadow, to more than 1000 to 1 when taking into consideration the additional background light from forward-scattering. Hence, the effects of forward-scattered light within the light extinction region defining the particle shadow may be considered negligible.

The particular area of the flow region 22 that comprises an illuminated measurement space casting particle shadow images to the camera 16 is determined by the depth-of-field (DOF) and field-of-view (FOV) produced by the imaging optics of the lens system 18 (see also FIG. 3). In other words, the optical characteristics of the image detecting system 14 determines a measurement space comprising a generally circular area (FOV) of predetermined diameter transverse to the center-line 26 and having a thickness parallel to the center-line 26 within which particles are imaged. In accordance with the set-up illustrated in FIG. 1, the DOF, the FOV and the working distance (WD) to a focal plane 34 defined by the lens system 18 may be adjusted by adjusting the spacing 21 between the camera 16 and the lens system 18, where the required spacing 21 is the product of the reproduction ratio, i.e., the magnification, and the focal length of the lens system 18.

The DOF decreases with increased spacing between the camera 16 and the lens system 18 and with increased aperture, i.e., lens diameter, where it is desirable to select the spacing and aperture to obtain a suitable DOF at the focal plane 34, i.e., a very thin focal plane, that is preferably less than a millimeter. As seen in FIG. 1, the lens system 18 may include a pair of lenses 28, 30 spaced from each other at a spacing 32. The spacing 32 between the lenses 28, 30 may be varied or adjusted to provide additional flexibility for adjusting the parameters FOD, FOV and WD. It should be noted that although commercially available lens systems may be implemented for the lens system 18, a custom designed lens system 18 may provide a smaller or more compact set-up for a given set of parameters. For example, in a typical lens set-up, the DOF may be on the order of 1-3 mm and the FOV may be varied from several millimeters to several centimeters, whereas increasing the diameters of the lenses 28, 30 could result in a narrower DOF that is preferably less than a millimeter, and a FOV is preferably on the order of 25 mm.

It should be noted that the size of particle used to seed the fluid flow will affect the DOF. Specifically, as the diameter of the particle decreases, the width of the DOF will also decrease. For the present system, it has been found that a particle size of approximately 10 μm or less will provide the preferred DOF that is less than 1 mm, while also providing a particle shadow area of sufficient size for detection.

Referring to FIG. 3, the DOF is illustrated diagrammatically with an exaggerated width dimension, and identified by reference numeral 56. In accordance with this illustration, the particle 52a, the shadow of which is fully contained within the defined DOF 56, may be fully imaged by the optics of the image detection system 14; whereas the shadows of the particles 52b and 52c, which are not fully contained with the DOF 56, will not be imaged at the camera 16 as sharply as the shadow of the particle 52a. In other words, particles passing through the location corresponding to the center of the focal plane, such as particle 52a, will be focused by the image detecting system optics, while particles passing through locations of increasing distance from the focal plane, such as depicted by the particles 52b and 52c, will be increasingly defocused and will appear as fainting background noise. The rate of defocusing may also be assumed to be proportional to the diffraction pattern of the particles (assuming they are point sources imaged through a circular aperture or lens), where the diffraction pattern will have a maximum intensity at the focal plane corresponding to the Airy function for Fraunhofer diffraction and will decrease rapidly with distance from the focal plane. The DOF may be defined as a specified fraction of the maximum intensity of the imaged particle located at the focal plane, effectively resulting in a two-dimensional slice of the imaged volume. On the other hand, the shadow diffraction rings resulting as the particle becomes defocused can be used to obtain out-of-plane velocity information.

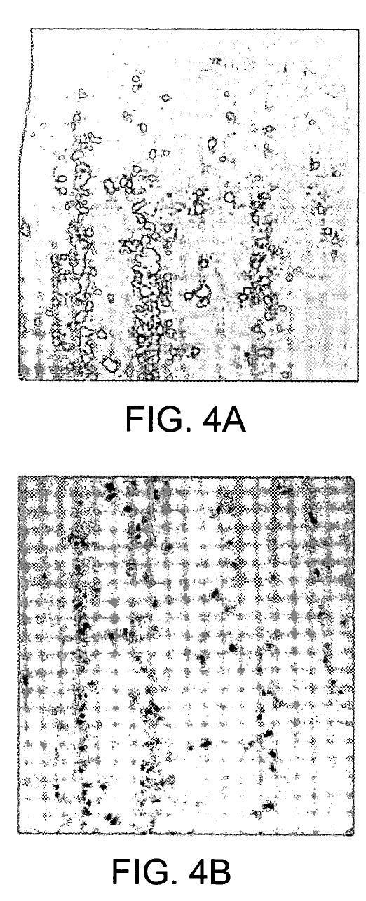

FIGS. 4A and 4B illustrate a contrast between an image that may be obtained using a conventional scattering PIV setup to collect side-scattered light (FIG. 4A), and using the presently described PSV setup (FIG. 4B). The images were produce by locating a glass plate having glass beads attached thereto (representing particles) at the focal plane of each of the setups. It can be seen that the PSV setup of FIG. 4B produces distinct particle images indicative of particle locations based on the particle shadows. The light source 10 for performing the PSV method preferably comprises a light source that may be pulsed rapidly at a wide range of pulse rates, while also providing sufficient illumination at high pulse rates. The preferred light source 10 comprises an LED or LEDs provided with a pulser 12 for controlling power to the LED(s) to control the timing between pulses and duration of the pulses. The selection of pulse characteristics is dependent upon velocity of the flow, as well as the magnification characteristics of the image detection system 14. Specifically, the pulses must be short enough to effectively freeze the movement of the particles while also providing sufficient illumination to be detected by the image detection system 14. That is, as the flow velocity increases, shorter pulses are required to freeze the motion of the particles. Also, it may be desirable to provide plural LEDs when illuminating high speed flows in order to increase the illumination with reduced pulse length. On the other hand, if shadow traces are recorded, such as may result from performing very high speed or high magnification experiments, cross correlation techniques between two trace fields may be used to provide the displacement as a function of time.

The camera 16 for performing the PSV method preferably comprises a CCD (charge-coupled device) camera. For example, a relatively inexpensive CCD camera found to be effective for many applications of the present method is a Nikon D70 camera available from Nikon, Inc. of Japan. Most CCD cameras have a higher sensitivity to red light, such that it may be preferable to provide the light source 10 as a red LED. However, the present method may also be practiced using other color LED light sources including, for example, blue and green LED light sources.

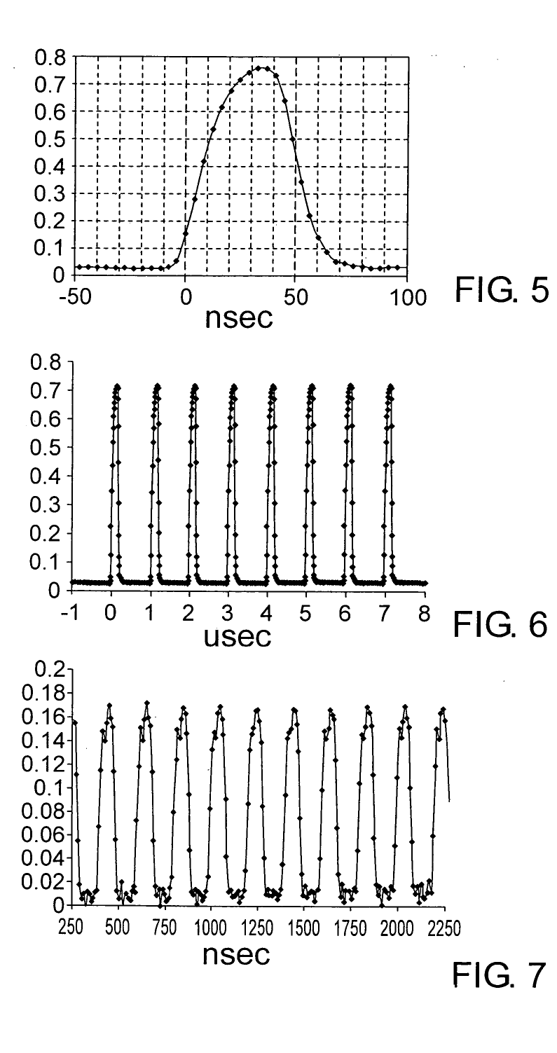

LEDs are capable of being pulsed at short pulse lengths in the range of tenths of nanoseconds, as may be seen in FIG. 5 showing an LED pulse of approximately 40 nsec. FIGS. 6 and 7 illustrate that a train of LED light pulses may be provided from the LED, where a wide range of variation may be provide in the time between pulses. For example, FIG. 6 illustrates a train of LED pulses where the time between pulses is on the order of 1 μsec, and FIG. 7 illustrates a train of LED pulses where the time between pulses is on the order of 200 nsec. It should be noted that a unique quality of the LED that is recognized herein is the ability to provide a reproducible light output, with a predictable ramp up and ramp down to each pulse (FIG. 5), having a variability on the order of less 1%. Accordingly, in measurements in which, for example, LEDs are pulsed with short intervals between pulses, such as may be utilized for high velocity flows, the LEDs provide a precise light source producing predictable time intervals between multiple images that may be recorded either on a single camera image frame or on multiple image frames.

The data obtained by the present method may be processed using known cross-correlation and auto-correlation techniques to determine velocity fields. In particular, the LED(s) may be pulsed and the data collected at the camera 16 either in a multiple exposure mode for analysis using an auto-correlation technique, or in a multiple frame mode for analysis using a cross-correlation technique. The images may be processed prior to performing a correlation technique in order to remove background noise that may be present in the images resulting from, for example, out-of-focus particle shadows. One example of a post-processing filter is a simple threshold filter that may be applied to the image before velocity processing. Other available filters that may be used to process the images produced by the present method include those based on an analysis of the spectral content of the images and the removal of low frequency components that are associated with the out-of-focus particle shadows. Such post-processing techniques, in which out-of-focus particle shadows are removed, may be used to effectively control the DOF to only include those particle shadows corresponding to particle passing through a focal plane of a predetermined width.

It should be noted that the present method may incorporate a light source 10 comprising plural LEDs of different colors for use in combination with a color CCD camera, wherein each color may be pulsed at a different time relative to the other color or colors in order to distinguish between multiple particle shadow images on a multiple exposure image taken by the camera. Further, use of three LED colors, i.e., red, blue and green, pulsed in sequence may be implemented to produce an image or images for determining acceleration fields from the particle shadows.

By way of example, a system similar to that shown in FIG. 1 may be provided in which the light source 10 comprises two LEDs or LED arrays emitting different colors, i.e., a red LED and a green LED, and the camera 16 may comprise a fast framing CCD camera. In a data collection process using the system, the two LEDs may be energized to pulse at two different times to provide two temporally spaced images of different colors on each image frame recorded by the camera 16. It should be understood that the time interval between the pulses of the two LEDs is selected to be shorter than the time interval between image frames of the camera 16.

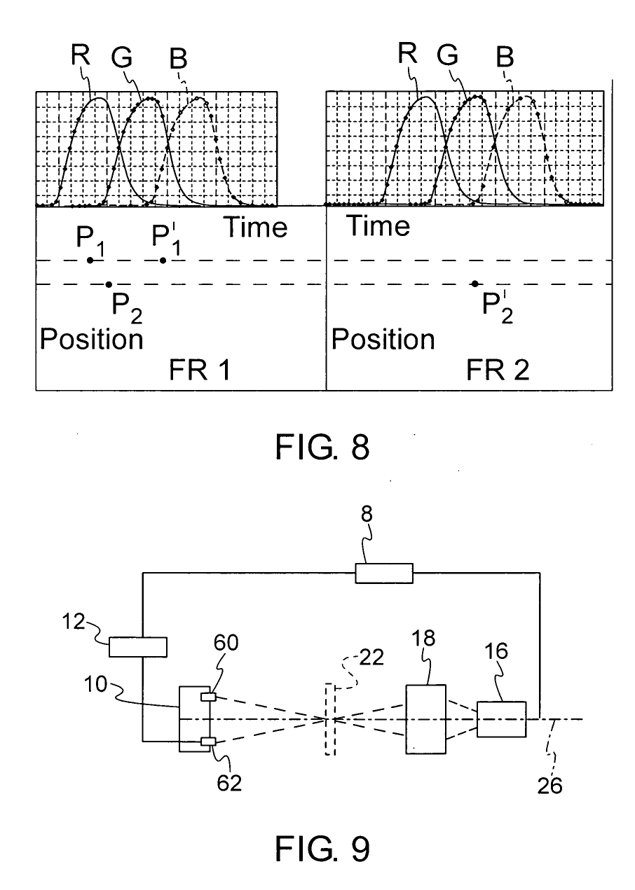

Referring to FIG. 8, a time-line illustrating the relative timing of the LED pulses and the successive frames is shown, in which it can be seen that a single pulse of each of the red (R) LED and the green (G) LED may provided for each image frame of the camera, illustrated as a first image frame FR 1 and a second image frame FR 2. In this example it can also be seen that the pulses of the red and green LEDs may temporally spaced by a short interval, seen here as overlapping pulses, to record very high velocities. The shadow from a particle moving at a high speed may be captured on a single image frame by both a red image and a green image produced from the red and green LEDs, and the velocity may be calculated based on the known timing between pulses and the spacing between the particle shadows as recorded in the red image, i.e., particle shadow P₁, and the green image i.e., particle shadow P₁′. In addition, if the flow has large velocity gradients, there may be slow moving particles that may not exhibit significant displacement in the time interval between the red and green LED pulses of a single image frame; however, the particle may still be present in the field-of-view when the second image frame is recorded. In this case, the slow moving particle shadow may be captured by either the red or green image of the first frame, i.e., particle shadow P₂, and may be compared to a shadow of the particle captured by either the red or the green image of the second frame, i.e., particle shadow P₂′, to obtain a velocity of this particle.

The timing between pulses of the different colored LEDs may be adjusted according to the high speed characteristics of a flow in order to capture the shadow images of a particle on a single frame. Further, the framing rate at which the camera 16 operates may be adjusted according to the low speed characteristics of the flow in order to capture the shadow images of a particle on multiple frames, i.e., for low speed particles. Also, it should be noted that the timing of the LEDs is preferably coordinated with the timing of the image frames to best capture the shadow images for a particular flow. Accordingly, the present imaging method provides four degrees or more of adjustment to provide capability of adjusting for a wide range of velocity with a single hardware system.

As a further extension of the above example, the light source 10 may include a blue LED which is energized to pulse at a time different from the pulse of the red and green LEDs, as indicated by the dotted line B in FIG. 8. The blue image produced by the blue LED may be used to provide an additional velocity determination based on the capture of shadows produced from a particle, either within a single image frame or between successive image frames. For example, a series of particle shadows formed by the red, green and blue LEDs on a single image frame may be used to provide two velocity measurements for a single particle based on the distance traveled between red and green pulses and the distance traveled between green and blue pulses, and the difference in the two velocity measurements, i.e., the change in velocity, may be used to determined the acceleration of the particle.

An additional example of the presently described method is illustrated in FIG. 9, showing a stereo set-up for shadow particle imaging. In the illustrated set-up, the light source includes a pair of LEDs 60, 62 separated from each other at a predetermined spacing. The LED 60 emits a different color light than the LED 62. Although the LEDs 60, 62 are separated from each other along a line perpendicular to the center-line 26, each of the LEDs projects a respective color particle shadow image to the lens system 18 and camera 16 and therefore is considered to be an in-line, direct illumination configuration. The different color shadow images projected by the LEDs 60, 62 to the camera 16 are offset relative to each other, and provide a stereo image of the portion of the measurement space 22 located within the depth of field. Further, as a result of the offset between the images a measurement component, or moment, in the direction of the depth of field may be obtained to provide a further dimension to the particle velocity measurement.

A particularly useful implementation of the present method is its use in applications where laser sheets would be impossible or impractical to use. For example, when imaging flows close to interior walls of turbomachinary, a setup as described herein may be implemented using an LED light source to image particle shadows without adverse affects of glare from the wall of the machine. In contrast, prior light scattering PIV techniques typically require use of a laser light at an energy level ten orders of magnitude greater than an LED, resulting in adverse effects due to glare produced by the high energy laser light reflected from the machine wall.

It should be understood that the terminology “in-line” as used herein is intended to encompass all in-line arrangements including optically formed in-line arrangements of components that may turn corners, such as may be implemented by mirrors. In other words, in-line, as used herein refers to a line extending generally directly through an object, such as a particle, from a source of light to a surface where a shadow of the object may be imaged, whether the surface comprises an optical sensing surface or an alternative arrangement of optical components preceding an optical sensing surface.

Further, it should be understood that the use of the singular LED may be interpreted to include plural LEDs, such as may be provided by an LED array, including an LED array comprising a plurality of LEDs of the same color.

As described above, the present invention generally provides a method for performing quantitative velocity measurements in a moving fluid flow and for real-time visualization of the fluid flow. The method described herein may be utilized in a variety fluid flows including, without limitation, fluid flows within wind tunnels, pipes, micro-channels, or any other fluid flow.

Further, the present method provides results substantially comparable to prior art PIV techniques that utilized scattered light to mark particle location, e.g., laser velocimetry techniques, while using lower power light sources that may be modulated or pulsed at higher pulse rates. It should additionally be understood that even shorter intervals between pulses may be obtained by providing plural LEDs controlled to pulse at predetermined short time intervals relative to each other, which may be timed to provide shorter intervals than could be provided by a single LED. Hence, the present method may be performed with a velocimetry system that may be constructed with a lower cost light source, i.e., an LED light source, while further providing control over modulation of the light source.

While the methods herein described constitute preferred embodiments of this invention, it is to be understood that the invention is not limited to these precise methods, and that changes may be made therein without departing from the scope of the invention which is defined in the appended claims.

What is claimed is:

1. A method of measuring fluid flow, the method comprising:
providing a light source comprising at least one LED;
providing an image detecting element;
defining an illuminated measurement space with an optical element located between the measurement space and the image detecting element, the measurement space being located optically in-line between the light source and the image detecting element;
providing a fluid flow through the measurement space, the fluid flow including particles;
illuminating the measurement space with the light source to induce light extinction from the particles comprising shadow markers of the position of the particles within the fluid flow; and
using the image detecting element to detect the shadow markers produced by the particles to record displacement of the particles as a function of time corresponding to movement of the fluid flow.

2. The method of claim 1, wherein the image detecting element detects the shadow markers produced by the particles at selected time intervals to provide multiple particle shadow images, and analyzing the multiple particle shadow images to describe a velocity field of the fluid flow.

3. The method of claim 1, wherein the image detecting element detects the shadow markers produced by the particles at selected time intervals to provide multiple particle shadow images, and analyzing the multiple particle shadow images to describe an acceleration field of the fluid flow.

4. The method of claim 1 wherein the LED light source comprises at least first and second LEDs emitting different colors.

5. The method of claim 4, wherein the first and second LEDs are energized to pulse at different times to produce temporally spaced images of different colors.

6. The method of claim 5, including a third LED emitting a different color than the first and second LEDs, and energized to pulse at a different time than the first and second LEDs.

7. The method of claim 5, wherein the images produced by pulsing of the LEDs are imaged to a fast framing color camera, and wherein a range of velocity measurements are provided by adjusting a time interval between pulses of the different colored LEDs imaged to a common image frame of the camera, and by adjusting the time interval between successive image frames of the camera.

8. The method of claim 4, wherein the images produced by pulsing of the LEDs are imaged to a color camera, and wherein the first and second LEDs are specially displaced from each other and are energized to pulse at the same time to produce a stereo image comprising two color images on a single image frame of the camera.

9. The method of claim 1, wherein the optical element comprises a lens system determining the depth of field of the particle shadow detection within the measurement space.

10. A method of measuring fluid flow, the method comprising:
projecting a light from a light source comprising at least first and second LEDs emitting different colors through a fluid flow seeded with particles to provide an illuminated measurement space;
imaging particle shadows from a portion of the illuminated measurement space to an image recording device; and
identifying particle locations from the particle shadows imaged to the image recording device as a function of time.

11. The method of claim 10, wherein the particle locations are identified by particle shadow locations contrasted to a lighter background produce by the light projected through the fluid flow.

12. The method of claim 10, wherein the light is projected from a light source located in an in-line configuration with the measurement space and the image recording device to produce the particle shadows on the image recording device.

13. The method of claim 10, wherein the image recording device comprises a color camera capable of recording image frames that distinguish between the different colors of the LEDs.

14. The method of claim 13, wherein the first and second LEDs produce at least two images of different colors on a single image frame.

15. The method of claim 13, wherein multiple color images of different colors are formed on a plurality of successive image frames.

16. The method of claim 15, wherein each of the LEDs are energized to pulse at different times to provide plural temporally spaced images on each image frame, and analyzing the images to determine velocity of particles in the measurement space.

17. The method of claim 15, wherein the first and second LEDs are energized to pulse at the same time to provide a stereo image of particles in the measurement space.

18. The method of claim 13, wherein the light source comprises a third LED emitting a different color than the first and second LEDs, and the first, second and third LEDs are energized to pulse at different times to produce temporally spaced images.

19. The method of claim 18, wherein the temporally spaced images are analyzed to determine acceleration of particles in the measurement space.

20. The method of claim 10, wherein particle locations are determined from shadow diffraction rings obtained from particles that are defocused relative to the measurement space.
